(19) United States
(12) Patent Application Publication
(10) Pub. No.: US 2014/0271300 A1
(43) Pub. Date: Sep. 18, 2014

(54) Progressive Cavity Pump/Motor Drive Mechanism

(71) Applicant: Roper Pump Company, Commerce, GA (US)

(72) Inventor: John Eugene Purcell, Commerce, GA (US)

(73) Assignee: Roper Pump Company, Commerce, GA (US)

(21) Appl. No.: 14/204,282

(22) Filed: Mar. 11, 2014

Related U.S. Application Data
(60) Provisional application No. 61/793,899, filed on Mar. 15, 2013.

(51) Int. Cl. F16H 13/06; F04C 2/107

(52) U.S. Cl. CPC F16H 13/06; F04C 2/1071
USPC 418/48; 475/183; 29/428

(57) ABSTRACT

A progressing cavity pump has a rotor that moves in an eccentric motion, and is driven by a drive shaft that rotates about a fixed axis. Various means have been used to connect the two; mostly using an intermediate shaft called a connecting rod that has a universal joint at either end. This device replaces that with two parallel plates; one with several pins protruding from it, and the other with the same number of holes in it. The holes are sized to allow the eccentric motion of the rotor. There is also a ball between the two plates to transmit loads between the plates.

### BACKGROUND OF THE INVENTION

1. Field of Invention

This invention relates to generally to progressive cavity or positive displacement pumps or motors, and more particularly, to drive arrangements for progressive cavity pumps or motors which have coupling mechanisms.

2. Description of Related Art

The use of progressive cavity, helical or single-screw rotary devices is well-known in the art, both as pumps and as driving motors. These devices typically include a rotor of helical contour that rotates within a matching stator. The rotor generally has a plurality of lobes or helices, and the stator has matching lobes. Generally, the rotor has one less lobe than the stator to facilitate pumping rotation. The lobes of the rotor and stator engage to form sealing surfaces and cavities therebetween. For a motor, fluid is pumped into the input end cavity at a higher pressure than that at the outlet end, which creates forces that cause the rotor to rotate within the stator. In the case of a helical gear pump, an external power source turns the rotors to draw fluid in the cavities and facilitate pumping of the fluid.

In progressive cavity pumps, the pump rotor centerline is eccentrically disposed relative to the centerline of the stator, typically by one unit of eccentricity. In operation, the rotor is rotated about its own centerline within the stator. As the rotor rotates, it also orbits about the centerline of the stator. If the rotor rotation is clockwise, then its orbital motion within the stator is in a counterclockwise direction, and vice versa. The ratio of orbital rotation to axial rotation depends on the number of lobes or helices in the rotor and stator.

With the rotor centerline being eccentric relative to the stator centerline, and the rotor rotating with axial and orbital rotation movement at the same time, the rotor rotates in a nutating motion relative to the stator and pump/motor housing. However, because of this nutating motion of the rotor, the rotor cannot be directly actuated by an external drive shaft. This problem resulted primarily from the failure to provide a drive train capable of handling the helix rotor driving motion in a durable, reliable and inexpensive manner. Both in the case of a motor, where fluid against the rotor provides the driving action, and also a pump, where the rotor is driven, a drive coupling mechanism, or coupling, is required to transform a rotation about a fixed axis to a rotation about an orbiting axis.

Various drive arrangements for cavity pumps have been devised to accommodate the nutating motion of the rotor. One common drive arrangement employs universal joint to provide power between the drive/driven shaft and the rotor. Another approach uses a flexible shaft instead of universal joints.

Still, a long term problem continues in providing an improvement in the operation and durability of couplings between the drive/driven shaft and the rotor of progressive cavity pumps and motors. The inventors have contemplated and solved this problem by inventing a drive coupling mechanism (e.g., coupler) including two spaced apart parallel plates with a driving arrangement between the plates that is inexpensive to produce and is durable and reliable in operation as will be described in greater detail below.

### BRIEF SUMMARY OF THE INVENTION

This summary is provided to introduce a selection of concepts in a simplified form that are further described below in the detailed description. This summary is not intended to identify the central feature of the claimed subject matter, nor is it intended for use in determining the scope of the claimed subject matter.

In accordance with an example of the invention, a drive coupling mechanism or coupling includes a first plate, a second plate, and a pin. The first plate is purposefully designed to be coupled to a shaft having a fixed axis. The second plate is eccentrically disposed adjacent to and spatially separate from the first plate. The second plate is purposefully designed to attach to a rotor having an orbiting axis, wherein a rotation of the rotor produces a circular path of the orbiting axis with a diameter of eccentricity. One of the first and second plates include a first cylindrical bore wall defining a first bore extending longitudinally toward the other one of the first and second plates. The pin is a first pin having a first end attached to the other one of the first and second plates, with the pin extending into the first bore and abutting the first cylindrical bore wall. The pin has a pin diameter less than the diameter of the bore. Preferably, the bore diameter is at least equal to the pin diameter plus the diameter of eccentricity of the orbiting axis of the rotor to allow rotation of the rotor and the shaft via the drive coupling mechanism. The drive coupling mechanism may further include a spacer between the first and second plates to keep the plates spatially separate.

Preferably, the spacer is a bearing or thrust bearing that may be contained to some degree in a recess of one of the plates. The drive coupling mechanism may also include a third plate, which may also be referred to as a securing plate. For an embodiment having the first pin attached to the first plate, the securing plate is preferably adjacent the second plate opposite the first plate with the first pin extending through the first bore in the second plate and attaching to the securing plate. It is understood that in addition to the first pin and first bore, the drive coupling mechanism may include additional pins and bores connecting the plates as described above with the first pin and first bore.

In accordance with another example of the invention, the drive coupling mechanism discussed above is part of a progressive cavity device that includes a stator and a rotor. In this example of a progressive cavity device, the stator defines a helically convoluted elongated chamber. The rotor is within the stator and includes a helically shaped shaft and a plurality of lobes with a profile that compliments the helically convoluted elongated chamber of the stator.

It is understood that one of the plates may be a drive plate attached to a drive shaft, which may also be used as a driven shaft or drill shaft. The other plate may be a rotor plate attached to a rotor shaft. During operation of the coupling in a progressive cavity device such as a pump, pressure at the outlet of the pump causes a net axial force on a rotor that pushes it toward the drive shaft. When the rotor is pushed toward the drive shaft, it pushes the spacer against the drive plate, where the thrust load is carried onto the spacer supporting the drive shaft. The spacer, which may be a thrust bearing, is free to roll around inside a bearing recess in one of the plates and a mating recess in the other plate opposite the bearing recess to allow parallel movement between the two plates.

In accordance with yet another example of the invention, a method for coupling a shaft having a fixed axis to a rotor having an orbiting axis, wherein a rotation of the rotor produces a circular path of the orbiting axis with a diameter of eccentricity is described. The method for coupling includes attaching a first pin to a first plate, with the first pin extending perpendicularly from the first plate, with the first pin having a pin diameter, a first end and a second end opposite the first end, with the first end being attached to the first plate, placing a second plate adjacent to and spatially separate from the first plate, with the second plate having a first cylindrical bore wall defining a first bore that extends longitudinally toward the first plate, the first bore having a bore diameter that is at least equal to the pin diameter plus the diameter of eccentricity of the orbiting axis, depositing the first pin into the first bore and abutting the first cylindrical bore wall of the second plate while maintaining spatial separation between the first plate and the second plate, fixedly securing one of the first plate and the second plate to the shaft having the fixed axis, and fixedly securing the other one of the first plate and the second plate to the rotor having the orbital axis, the shaft and the rotor being coupled via a drive coupling mechanism including the first plate, the second plate and the first pin to allow rotation of the rotor and the shaft via the drive coupling mechanism.

Further scope of applicability of the present invention will be apparent from the detailed description given hereafter. However, it should be understood that any examples described herein, while indicating preferred embodiments of the invention, are given by way of illustration only, and that the invention is not limited to the precise arrangements and instrumentalities shown, since the invention will become apparent to those skilled in the art from the detailed description.

All references cited herein are incorporated herein by reference in their entireties.

### BRIEF DESCRIPTION OF SEVERAL VIEWS OF THE DRAWINGS

The invention will be described in conjunction with the following drawings in which like reference numerals designate like elements and wherein:

FIG. 1 is a side view, partially in section, of an exemplary drive coupling mechanism or coupler in accordance with the invention;

FIG. 2 illustrates the coupler of FIG. 1 in perspective view;

FIG. 3 is a side perspective view of another example of a coupler in accordance with the invention;

FIG. 4 illustrates the coupler of FIG. 3 taken along line 4-4 thereof;

FIG. 5 is a side view of the coupler of FIG. 3 attached to an exemplary rotor and drive shaft; and

FIG. 6 illustrates the coupler depicted in FIG. 5, including the coupler, within a progressive cavity pump.

### DETAILED DESCRIPTION OF THE INVENTION

The present invention will now be described with reference to examples provided in the accompanying drawings, in which preferred embodiments and examples of the invention are shown. This invention may, however, be embodied in many different forms and should not be construed as limited to the embodiments set forth below. Rather, these exemplary embodiments are provided so that this disclosure will be thorough and complete, and will fully convey the scope of the invention to those skilled in the art.

FIG. 1 depicts an exemplary embodiment of a drive coupling mechanism or coupler 10, partially in section, to better shown structural features of the coupler. In particular, FIG. 1 shows the coupler 10 having a drive plate 12, a rotor plate 14, pins 16 and a spacer (e.g., bearing 18). The drive plate 12 and rotor plate 14 are purposefully designed in parallel and separated by a small gap. The drive plate 12 is attached to an axially rotative drive shaft 20 and the rotor plate 14 is shown attached to an orbitally rotative rotor shaft 22 having a centerline eccentrically disposed (e.g., a diameter of eccentricity Dₑ) relative to the drive shaft. It is understood that the plates may be attached to their respective drive shaft 20 and rotor shaft 22 directly or indirectly, with central members, such as shafts or couplings therebetween. In this example, it is understood that the drive plate 12 is fixedly secured, directly or indirectly with the drive shaft 20. Likewise, it is understood that the rotor plate 14 is fixedly attached, directly or indirectly with the rotor shaft 22.

At least one of the pins 16 is attached to a first plate, which is illustrated as the drive plate 12 but may be either the drive plate or the rotor plate 14. The pins 16 are preferably cylindrical and have a first end attached inside apertures 24 of the drive plate 12 such that the pins extend from the drive plate towards and into the rotor plate 14. Each pin 16 has a diameter slightly smaller than and preferably about the same size as the respective drive plate aperture 24 for each pin.

Still referring to the example of FIG. 1, the pins 16, preferably made of steel, metal or like material for strength, longevity and rigidity, are attached to the drive plate 12, preferably with the pin 16 bonded into apertures 24 within the drive plate 12. While not being limited to a particular theory, the apertures 24 fixedly receive the pins 16 and hold the pins in place during operation of the coupler 10. It should be noted that the pins 16 preferably are longitudinally fixed within in the apertures 24 of the drive plate. The pins 16 may also be fixed rotationally in the apertures 24. However, it is understood that the invention is not so limiting, as the pins 16 may rotate within the drive plate apertures 24 if desired, for example via a busing or bearings between the pins 16 and the apertures.

The rotor plate 14 includes a plurality of cylindrical bore walls 26, each defining a bore 28 extending longitudinally toward the drive plate 12. The bore walls 26 and associated bores 28 are spaced apart around the rotor plate 14 so that each bore may receive one of the pins 16 within its bore walls. Each bore 28 is significantly wider than the respective pin 16 housed within its associated bore wall 26. Preferably, each bore 28 has a bore diameter that is equal to or greater than the diameter of the respective pin 16 within the bore plus the diameter of eccentricity Dₑ of the orbiting axis to allow rotation of the rotor shaft 22 and the drive shaft 20 via the coupler 10, with the rotor and drive shafts preferably maintaining a parallel relationship during rotation. The diameter of eccentricity Dₑ is also understood to be the diameter of the circular path traced by the axis of the rotor shaft 22 during a rotation of the rotor. During a rotation of the drive shaft 20, contact between the pins 16 and the bore walls 26 drives the rotor plate 14, and by association, the rotor shaft 22, while the bores larger diameter relative to the pins 16 allows for the eccentric or gyrational rotation of the rotor shaft and nutating movement of an attached rotor.

The pins 16 enter bores 28 of the second plate, which in the example is the rotor plate 14. In particular, the drive and rotor plates 12, 14 are aligned so that each pin 16 extends through a mating bore 28 of the second plate and extends at least partially through the bore. As discussed above, each of the mating bores 28 preferably has a diameter at least equal to the diameter of the pin 16 plus the diameter of eccentricity D_{E} of the orbiting axis of the rotor. During operating, the pins 16 abut the cylindrical bore walls 26 of the second plate to rotate the second plate upon rotation of the first plate. It is understood that in another example, the plates may be reversed, with the drive plate 12 having the bore walls 26 and bores 28, and the rotor plate 14 holding the pins 16 that extend through bores of the drive plate. In this operation, rotation of the drive plate 12 with the bores drive the pins 16 causing rotation of the attached rotor plate.

During operation of the coupler 10, for example within a pump, pressure at the outlet of the pump creates an axial force on the rotor that pushes the rotor shaft 22 toward the drive shaft 20. However, it is preferred that the parallel drive plate 12 and rotor plate 14 remain spatially separated by a gap 30 to prevent rubbing friction there between that would be caused by the sliding of the plates against each other. In order to prevent this undesired contact between the plates, a spacer may be housed between the plates 12, 14. By non-limiting example, the spacer is preferably a spherical ball or thrust bearing 18 made of steel or other hard durable material. The drive plate 12 includes a bearing recess 32 for containing the bearing 18 between the plates while preferably allowing the bearing to roll. Accordingly, the plates 12, 14 are preferably spaced apart by a gap 30 so that the plates do not rub against each other during operation. The spacer (e.g., spherical ball, thrust bearing 18) is provided between the plates to maintain a spatial separation of the gap 30 therebetween.

In operation, the thrust bearing 18 is free to roll around inside the bearing recess 32 and against the rotor plate 14 to allow parallel movement between the two plates. In order to help contain the bearing 18 between the two plates, the rotor plate 14 may include a mating recess 34. Preferably, the mating recess 34 has a circular cutout or annular groove 36 within the rotor plate 14 that is aligned with the bearing 18 during rotation of the drive and rotor plates 12, 14 to allow the bearing to roll around within the mating recess and the bearing recess 32 during rotation for parallel rotational movement between the drive and rotor plates. In other words, the spacer is contained in the recess 32 of one of the plates and also within the mating recess 34 in the other plate so that the spacer may be contained between the plates, thereby providing the gap 30 therebetween. While not being limited to a particular theory, the circular cutout or annular groove 36 is sized with a diameter preferably equal to or slightly larger than the diameter of eccentricity of the orbiting axis. Most preferably the bearing recess 32 and the mating recess 34 are sized to allow the spacer to move around and stay within the recesses during operation. According the size of one of the recesses may affect the preferred sized of the other recess, as readily understood by a skilled artisan.

FIG. 2 illustrates the exemplary coupler 10 in perspective view. In this view, the relationship of the pins 16 and bores 28 can clearly be seen between the four pins rotatably and orbitally engaged with the bore walls 26 of the matching bores 28. The rotor plate 14 and rotor shaft 22 are shown in opaque transparent view to show an exemplary rotating orbital relationship between the bearing 18 and the mating recess 34 of the rotor plate 14. As can be seen in FIG. 2, the mating recess 34 is defined by an annular groove 36 having a mean diameter 40 about equal to the rotor plate diameter of eccentricity Dₑ.

While not being limited to a particular theory, the pins 16 preferably extend completely through the bores 28 to maximize driving contact between the pins 16 and bore walls 26 of the rotor plate 14. In other embodiments, the pins 16 may extend partially into the rotor plate 14. However, to maximize the transfer force onto the rotor and reliability of the coupler or coupling mechanism, the pins 16 are preferably extend completely through the bores 28, with distal ends 38 of the pins extended through the bores 28.

FIGS. 3 and 4 depict another example of the inventive coupler substantially similar to the coupler 10 illustrated by example in FIGS. 1 and 2. In particular, the coupler 50 includes at least the drive plate 12, rotor plate 14, pins 16, bearing 18, drive shaft 20 and rotor shaft 22 substantially as discussed above. In addition to the coupler 10, the coupler 50 includes a securing ring 52 adjacent to and preferably spatially separate from the rotor plate 14. The securing ring 52 is placed about the rotor shaft 22 and preferably not in contact with the shaft as that would cause greater friction during use. The securing ring 52 includes ring apertures 54 that match the apertures 24 of the drive plate 12. As can be seen in FIGS. 3 and 4, the pins 16 are also attached to both the drive plate 12 and the securing ring 52, with the ring apertures 54 of the securing ring aligned with the pins. The distal ends 38 of the pins 16 are inserted into the apertures 54 and attached to the securing ring 52 via their attachment to the securing ring walls that define the apertures. In this construction, the second plate, illustrated as the rotor plate 14 is between the first plate illustrated as the drive plate 12 and the securing ring 52. The securing ring 52 encircles the rotor shaft 22 and includes an opening therein large enough to accept the orbital eccentric rotation of the rotor shaft preferably without contact with the rotor shaft.

The distal ends 38 of the pins 16 fit into the apertures 54 and attach to the securing ring 52 on the side of the rotor plate 14 opposite the drive plate 12 to provide greater stability to the assembly of the plates, pins and spacer that together form the coupler 50. For example, the securing ring 52 helps to prevent the deforming of any pin 16 as the pins are secured to the drive plate 12 and securing ring 52 on opposite ends of the rotor plate 14 to structurally secure and stabilize the entire mechanism. The securing ring 52 preferably has an equal number of apertures 54 or fastening holes relative to the pins 16.

The drive plate 12 illustrated in FIG. 3 is directly attached to a connecting rod 56 similar to the drive shaft 20 and having diametrically disposed connecting rod bores 58 for locking the connecting rod 56 to a drive shaft or driven shaft as discussed in greater detail below. Further, the rotor shaft 22 also includes a diametrically disposed connecting rod bore 58 for locking the rotor shaft 22 to a rotor 62 as will be discussed in greater detail below.

FIG. 5 depicts the coupler 50 of FIG. 3 attached to a rotor 62 and drive shaft 60. A shaft clamp 64 is placed about the drive shaft 60 and connecting rod 56 with a sleeve 66 of the drive shaft fitted around and in contact with the connecting rod 56. Preferably, a bolt 68 is inserted through an opening of the clamp 64 and into the connecting rod bore 58 of the connecting rod 56 to hold the drive shaft 60 and the connecting rod together. While not being limited to a particular theory, the bolts 68 may be threaded for a threaded engagement with at least one of the opening of the clamp 64, the connecting rod bore 58 and the drive shaft sleeve 66 to fixedly lock the clamp, connecting rod and drive shaft. FIG. 5 also illustrates a second clamp 64 holding the rotor 62 and the rotor shaft 22 together. In particular, the second clamp 64 is inserted around the rotor sleeve 66, which is slid over the rotor shaft 22. Preferably, a bolt 68 is inserted through an opening of the second clamp 64 and into the connecting rod bore 58 of the rotor shaft 22 to hold the rotor 62 and the rotor shaft together. Preferably, the bolt 68 that locks the rotor 62 to the rotor shaft 22 is threaded for threaded engagement with at least one of the opening of the second clamp 64, the opening in the sleeve 66, and the rotor shaft bore 58 so that the bolt 68 can easily be tightened against the clamp 64 and fixedly lock the clamp, rotor and rotor shaft together.

FIG. 6 illustrates the structure depicted in FIG. 5, including the coupler 50, within a progressive cavity pump 80. The pump 80 includes a stator 82 with the rotor 62 mounted in the stator. In addition, the pump 80 has an intake housing at an inlet of the pump, and a connection or press fitting 86 at the pump outlet. The pump 80 is shown attached to legs 88 which may allow securement of the pump to a floor or base as desired. In operation, a shaft having a fixed axis (e.g., drive shaft 20, driven shaft, drill shaft) is coupled to the rotor 62 having an orbiting axis, where a rotation of the rotor produces a circular path of its orbiting axis with a diameter of eccentricity D_{E}.

While the invention has been described in detail with reference to specific examples thereof, it will be apparent to one skilled in the art that various changes and modifications can be made therein without departing from the spirit and scope thereof. For example, the drive shaft 20 of the pump may, for example, also be a driven shaft or drill shaft when the coupler is used in a motor. In addition, the plates 12, 14 may be interchanged, with the plate including the bore walls 26 being attached to the drive shaft, and the plate having the pins attached thereto being attached to the rotor shaft. That is, plates and shafts may be interchanged within the scope of the invention. Moreover, the pins 16 that are shown bonded to the drive plate 12 may instead be fixed within the plate apertures 24 and rotatable therein, as would readily be understood by a skilled artisan. Without further elaboration, the foregoing will so fully illustrate the invention that others may, by applying current of future knowledge; readily adapt the same for use under various conditions of service.

What is claimed is:

1. A drive coupling mechanism, comprising:
a first plate configured to couple to a shaft having a fixed axis;
a second plate eccentrically disposed adjacent to and spatially separate from the first plate, the second plate configured to attach to a rotor having an orbiting axis, wherein a rotation of the rotor produces a circular path of the orbiting axis with a diameter of eccentricity;
one of said first plate and said second plate including a first cylindrical bore wall defining a first bore extending longitudinally towards the other one of said first plate and said second plate;
a first pin having a first end attached to said other one of said first plate and said second plate, said first pin extending into said first bore and abutting the first cylindrical bore wall, said first pin having a pin diameter, said first bore having a bore diameter, said bore diameter being at least equal to the pin diameter plus the diameter of eccentricity of the orbiting axis to allow rotation of the rotor and the shaft via the drive coupling mechanism.

2. The drive coupling mechanism of claim 1, further comprising a spacer between said first plate and said second plate to keep said plates spatially separate.

3. The drive coupling mechanism of claim 2, said spacer including a bearing.

4. The drive coupling mechanism of claim 3, one of said first plate and said second plate including a recess for containing the bearing.

5. The drive coupling mechanism of claim 4, the other one of said first plate and said second plate including an annular grove within said plate and aligned with the bearing to allow the bearing to roll around in the annular grove during rotation of said first and second plates for parallel movement between said first and second plates.

6. The drive coupling mechanism of claim 5, said annular grove having a mean diameter substantially equal to the diameter of eccentricity of the orbiting axis.

7. The drive coupling mechanism of claim 1, said first end of the first pin being attached to said first plate, said drive coupling mechanism further comprising a securing ring adjacent said second plate opposite said first plate, said first pin having a second end opposite the first end and extended through said first bore, said securing ring attached to the second end of the first pin.

8. The drive coupling mechanism of claim 1, said one of said first plate and said second plate that includes the first cylindrical bore wall further comprising a plurality of additional cylindrical bore walls, each of the plurality of cylindrical bore walls defining an additional bore extending longitudinally towards the other one of said first plate and said second plate, the drive coupling mechanism further comprising a plurality of additional pins, each of the additional pins attached at one end thereof to said other one of said first plate and said second plate, each of said additional pins extending into a respective one of said additional bores and abutting the respective additional cylindrical bore wall, each of the additional pins having a respective pin diameter, each of said additional bores having a respective bore diameter being at least equal to the respective pin diameter of the respective pin extending into the respective additional bore plus the diameter of eccentricity of the orbiting axis.

9. The drive coupling mechanism of claim 1, further comprising a connecting rod axially fixed to said first plate, said connecting rod being configured to attach said first plate to the shaft.

10. The drive coupling mechanism of claim 9, further comprising a shaft clamp that fixedly secures said connecting rod to the shaft.

11. The drive coupling mechanism of claim 1, said first plate being fixedly attached to said shaft.

12. The drive coupling mechanism of claim 1, said shaft being a drive shaft.

13. A method for coupling a shaft having a fixed axis to a rotor having an orbiting axis, wherein a rotation of the rotor produces a circular path of the orbiting axis with a diameter of eccentricity, the method comprising:
attaching a first pin to a first plate, with the first pin extending perpendicularly from the first plate, the first pin having a pin diameter, a first end and a second end opposite the first end, with the first end being attached to the first plate;
placing a second plate adjacent to and spatially separate from the first plate, the second plate having a first cylindrical bore wall defining a first bore that extends longitudinally towards the first plate, the first bore having a bore diameter that is at least equal to the pin diameter plus the diameter of eccentricity of the orbiting axis;
depositing the first pin into the first bore and abutting the first cylindrical bore wall of the second plate while maintaining a spatial separation between the first plate and the second plate;
fixedly securing one of the first plate and the second plate to the shaft having the fixed axis; and
fixedly securing the other one of the first plate and the second plate to the rotor having the orbital axis, the shaft and the rotor being coupled via a drive coupling mechanism including the first plate, the second plate and the first pin to allow rotation of the rotor and the shaft via the drive coupling mechanism.

14. The method of claim 13, further comprising dispensing a spacer between the first plate and the second plate to maintain the spatial separation there between.

15. The method of claim 13, further comprising extending the second end of the first pin through the first bore, and attaching the second end of the first pin to a securing ring adjacent the second plate and opposite the first plate.

16. A progressive cavity device, comprising:
a stator defining a helically convoluted elongated chamber;
a rotor within said stator, said rotor including a helically shaped shaft and a plurality of lobes with a profile that compliments the helically convoluted elongated chamber of said stator, said rotor having an orbiting axis, wherein a rotation of the rotor produces a circular path of the orbiting axis with a diameter of eccentricity; and
the drive coupling mechanism of claim 1, said second plate being fixed to said rotor.

17. The progressive cavity device of claim 16, further comprising a spacer between said first plate and said second plate to keep said plates spatially separate.

18. The progressive cavity device of claim 16, said first pin having a first end attached to said first plate, said drive coupling mechanism further comprising a securing ring adjacent said second plate opposite said first plate, said first pin having a second end opposite the first end and extended through said first bore, said securing ring attached to the second end of the first pin.

19. The progressive cavity device of claim 16, said one of said first plate and said second plate that includes the first cylindrical bore wall further comprising a plurality of additional cylindrical bore walls, each of the plurality of cylindrical bore walls defining an additional bore extending longitudinally towards the other one of said first plate and said second plate, the drive coupling mechanism further comprising a plurality of additional pins, each of the additional pins attached at one end to said other one of said first plate and said second plate, each of said additional pins extending into a respective one of said additional bores and abutting the respective additional cylindrical bore wall, each of the additional pins having a respective pin diameter, each of said additional bores having a respective bore diameter being at least equal to the respective pin diameter of the respective pin extending into the respective additional bore plus the diameter of eccentricity of the orbiting axis.
